(19) United States
(12) Patent Application Publication
(10) Pub. No.: US 2002/0073024 A1
(43) Pub. Date: Jun. 13, 2002

(54) System and methods of using wireless communication devices to conduct financial transactions

(76) Inventor: Alexander Sandy Donald Gilchrist, Fowey Cornwall (GB)

Correspondence Address: DAVID TOREN, ESQ., SIDLEY, AUSTIN, BROWN & WOOD, LLP, 875 THIRD AVE, NEW YORK, NY, 10022, US

(21) Appl. No.: 09/732,430

(22) Filed: Dec. 7, 2000

(51) Int. Cl. G06F 17/60

(52) U.S. Cl. 705/39

(57) ABSTRACT

The invention is directed to a system and method for electronic funds transfer, comprising the steps of receiving consumer data at a server from a consumer device or merchant unit, checking the validity of the received data; transferring wireless fund values form a consumer account to a merchant account in a database and sending an authorization signal from the server to a merchant device connected thereto.

### FIELD OF THE INVENTION

The present invention generally relates to a system and method of using wireless communication devices to conduct financial transactions involving the transfer of finds between e-cash accounts. More particularly, the invention relates to using a cellular phone or pervasive computing device to access such e-cash accounts, which correspond to prepaid, cellular phone air-time, so that a consumer may purchase goods and services.

### BACKGROUND OF THE INVENTION

Remote memory, prepaid accounts for use in purchasing goods and services are generally well known. Prepayment is advantageous in that it satisfies all parties involved in a transaction: allaying the seller's concerns regarding due payment for goods or services rendered and providing consumers with the otherwise unlikely ability to obtain goods or services.

Presently known schemes typically involve prepaid long distance telephone calling cards that include a unique authorization or account number and instructions for access to funds, services, and the like. Upon exhaustion of the economic value, the cards are thrown away. Such known prepaid cards are disadvantageous because the need to constantly purchase new prepaid cards is burdensome to the consumer and costly to the manufacturer since new cards must be produced and distributed.

Other known schemes provide prepaid cards capable of being regenerated by increasing the account balance. Typically, a consumer regenerates the card by connecting to the host computer, entering a credit card number and expiration date, home zip code, and a regenerate amount. The consumer then directs the host system to withdraw funds from the credit card and deposit the funds into the prepaid card account.

Also known are stored value cards (e.g., “smart cards”) wherein a remaining account balance is stored within a microprocessor controlled memory resident in the card. Such smart cards are capable of repetitively storing information representing value that is likewise deducted for specific purposes.

The concept of pre-paid accounting also exists in the mobile telephony market. For example, debit phones include regular cellular phones with a prepaid number of call credits. Debit phones are typically used in markets where fraud or the occurrence of people not paying their bills is prevalent. In such systems, if the account reaches zero (or a negative value) the pre-paid system orders the mobile network to bar the subscriber from making additional calls. A dedicated service number to an Interactive Voice Response (IVR) subsystem can be associated with such an accounting system, which a service subscriber can call and request the account's balance. In particular, the IVR provides an interactive voice session in which the system generates voice messages through recording or synthesizing techniques, and the consumer interacts using a telephone keypad or through voiced statements and voice recognition.

Moreover, some of the existing systems combine the use of pre-paid in the mobile telephony market with the use of a user card.

International patent application WO 94/11849 , for example, discloses a system for effecting payments with the aid of mobile telephony (GSM). In the known system, the rights of the user are checked with the aid of the user card (SIM) and an identification code which is checked locally.

International Patent Application WO92/2 1110 discloses a system for the acquisition of services using a telephone set equipped with a smart card reader. The smart card is used to identify the user. This known system provides a coupling between the smart card of a user and the computer of a service provider, but does not comprise a specialized system for facilitating remote transactions.

The above-mentioned prior art documents are herewith incorporated by reference in this text.

The above prior art systems are disadvantageous for people who do not have bank and/or credit card accounts. Moreover, reliance on bank accounts is not always convenient. For example, the transfer of funds from one account, in bank A, to another account, in bank B, may take as many as three (or more) days. Further, the opening of a new bank account must occur during regular business hours.

### SUMMARY OF THE INVENTION

The present invention overcomes the problems of the prior art by providing a system and methods for accessing Internet based e-cash accounts, via Internet or wireless connections, to transfer funds between such e-cash accounts or to perform other authorized activities.

It is an object of the invention to provide a system and method that offers real time settlement, heightened security and easy access anytime, anywhere, anyplace to e-cash.

It is a further object of the invention to provide an alternative payment method for people who do not have a bank or credit card account.

In accordance with the present invention, a method is used to transfer funds between different e-cash accounts including the step of receiving account and authorization information.

Preferably, the method includes the steps of recognizing the consumer identity by using a computerized system including a call management feature for prepaid calls. The call management feature recognizes the origination and identification information of the originating call. The consumer information including account balance associated with the identification information is looked up in a consumer data database. If the consumer is not in the database (i.e. does not have an e-cash account) the system provides for immediate registration of the new consumer. Additionally, the computerized system includes an authorization feature that is used to authorize a consumer's access to the system by using a verification process to verify a consumer identity based on the password typed in by the consumer on the keypad of a cellular phone or other wireless communication device.

According to the invention, there is provided an e-cash funds transfer system having at least one merchant unit connected to a server, each merchant unit having means for receiving a signal from the server authorizing the transaction; the server being associated with a database for storing data relating to consumers of the e-cash funds transfer system, and having: means for receiving consumer data from a consumer device, preferably a mobile telephone; means for checking the validity of said received data; and means for transmitting authorization data to the merchant unit.

### BRIEF DESCRIPTION OF THE DRAWINGS

Novel features and advantages of the present invention in addition to those mentioned above will become apparent to persons of ordinary skill in the art from a reading of the following detailed description in conjunction with the accompanying drawing. Accordingly, there are shown in the drawings certain exemplary embodiments of the invention as presently preferred. It should be understood that the invention is not limited to the embodiments disclosed as examples, and is capable of variation within the scope of the appended claims. In the drawings,

FIG. 1 illustrates the basic components of a system consistent with the present invention.

FIG. 2 illustrates a preferred method of practicing the method of the present invention using the system of FIG. 1.

### DETAILED DESCRIPTION OF THE INVENTION

The invention relates to a system and method for charging or recharging an account in a networked prepaid system for a mobile telephone with a value corresponding to a sum of money.

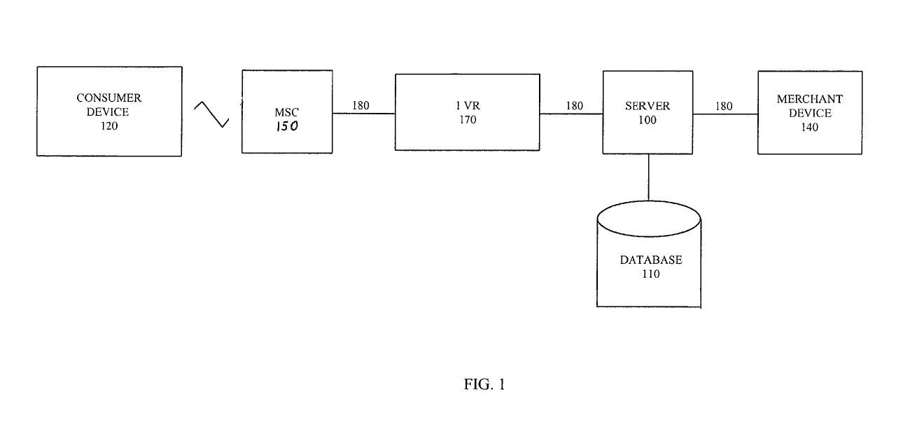

Referring now to FIG. 1, the system includes a server 100, a database 110, a consumer device 120, a merchant unit 140 (Electronic Funds Transfer at Point of Sale (EFTPOS)), an Intelligent Voice Recognition Computer (IVR) 170, and communication channels 180. In accordance with the invention, server 100 communicates with consumer device 120 and merchant unit 140, via communication channels 180.

The communication channels 180, which provide the communication between a consumer (via a consumer device 120), a merchant (via a merchant unit 140) and the server 100, are preferably constituted by a mobile communication network, such as e.g. a GSM or DECT network, but may be another fixed communication network, such as an ISDN network. In the example shown, the communication channels 180, are telephone lines. Consumer devices 120 (e.g., fixed or mobile) can, however, access server 100 from one or more of a number of other communications networks 160 (e.g., PSTN, ISDN, PLMN, etc.). The communication connection with IVR 170 can also be based on fixed connections, wireless communication or their combinations.

The consumer device 120 may be a cellular telephone set, a mobile telephone, an ISDN set , PC, lap top or other wireless device. The server 100 preferably comprises IVR 170, which may be controlled by DTMF tones generated by either the consumer's device 120 or by the response unit itself.

Server 100 includes storage devices such as a hard disk drive, a magnetic drive and CD-ROM drive or other nonvolatile storage media that may be used to transport computer executable instruction and data structures. Although the description of computer-readable media above refers to a hard disk, removable magnetic disc and a CD, it should be appreciated by those skilled in the art that other types of media which are readable by a computer such as magnetic cassettes, flash memory cards, digital video disks cartridges and the like, may also be used in the operating environment. Software programs, which are stored in server 100 direct the operation of the system.

When the consumer enters calling information (i.e., dials a telephone number) via the wireless handset of the consumer device 120, the wireless handset signals to a mobile switching center (MSC) 150. Each MSC 150 has a corresponding database (not shown) containing consumer information. The MSC 150 communicates with the server database 110 via IVR 170 and server 100, respectively. The database 110 monitors charges incurred by the user. The transactions carried out between a merchant and the consumer are also stored in this database 110. The merchant also has an account in the database 110.

There is also an authentication function, which carries data relating to the individual consumers. Each cellular subscriber is identified by a combination of a discrete Mobile Identification Number (MIN) and a specific Electronic Serial Number (ESN) which are passed from the “remote” cellular carrier to the subscriber's home carrier by existing IS-41 (Rev. A) messaging protocols in response to a request for service by a subscriber roaming within the service area of the remote carrier. Based upon the MIN/ESN, the home carrier electronically verifies whether the cellular subscriber may have access to the requested services.

Server 100 receives calls from the consumer device 120 via MSC 150 including the MIN/ESN and then determines the consumer account information from the numbers received. If the account information passes all the checks, i.e., monetary value corresponding to airtime units are available, server 100 sends a confirmation to merchant unit 140.

The server 100 maintains the account that has funds withdrawn or otherwise consumed as a consequence of the telephone calls placed with the consumer device 120. IVR 170 then instructs the user to enter an authorization code on the consumer device 120. The server 100 prompts the caller using consumer device 120 to enter the amount of funds to be transferred from the consumer account to the merchant unit 140. The consumer using consumer device 120 suitably enters the amount on the phone keypad. In an alternative embodiment, the consumer speaks the amount into the telephone whereupon IVR 170 recognizes and interprets the verbal command.

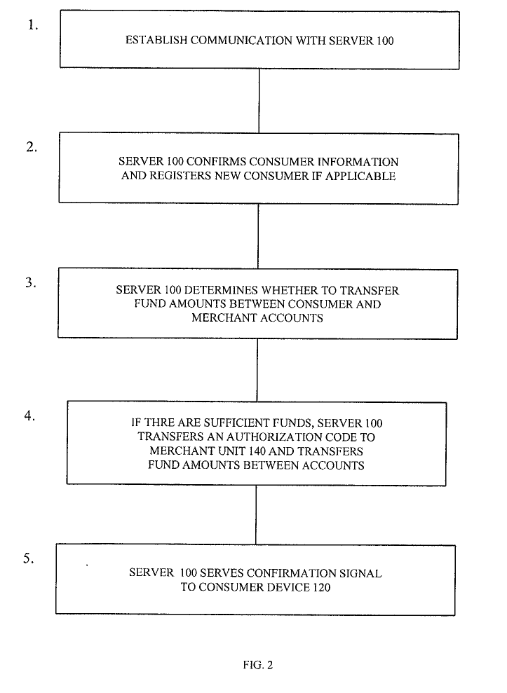

FIG. 2 illustrates the preferred method of practicing the invention.

In step one, communication is established between consumer device 100 or merchant unit 140 and the system's IVR 170 in conjunction with server 100. In particular, in step one, subsection a, a consumer using consumer device 120 communicates with server 100.

When the consumer device 120 is a cellular phone, then the cellular phone identification number together with a PASSWORD constitute the consumer unique identifying code. Alternatively, when another consumer device 120, such as a personal computer (PCs), laptop, palm and the like, are used then the consumer enters an identification code and PASSWORD on a keyboard. Additionally, the consumer, using any consumer device 120 enters, via the keypad, the transaction type, and the amount of e-cash he wishes to transfer, and the destination identification of the e-cash transfer.

The consumer uses the telephone handset key board of consumer device 120 to set up a connection with the IVR 170 of server 100. The consumer registers or selects transaction functions by entering numbers on the keyboard, possibly in reply to questions posed by the IVR 170.

For example, IVR 170 prompts the consumer device 100 with a menu of options to choose from: option 1—“transfer funds between e-accounts”, option 2—“check balance”. To enter an amount, the consumer using consumer device 120 presses the “SEND” key, the IVR 170 then prompts the consumer with the “OK”? key and the consumer presses the “SEND” key or clears and re-enters amount using the consumer device 120.

IVR 170 receives the information automatically transmitted from the consumer device 120 and the password, relating to safe identification, for reliably identifying the consumer and for retrieving information, from a database, such as database 110 via server 100.

Alternatively, in step one, merchant unit 140 is used by the merchant to enter the consumer identification information and the consumer to enter the PASSWORD and destination identification. If the consumer's information is recognized by the server 100, then the computer prompts the user to enter an amount, “SEND” it, then prompts “OK”? and the merchant presses “SEND” or clears and re-enters amount.

In step 2, server 100 checks the identity and authenticity of the consumer identification information and the PASSWORD by comparing the received information with consumer information in database 110. The consumer starts the payment process by pressing certain keys on his consumer device 120 keyboard in response to instructions received by the IVR 120. A particular key may serve to discontinue the transaction. In the event that the payment process does take place, the subscriber line of the consumer is connected to the server 100 through communication channels 180.

If the server 100 determines that the consumer identification information is not in database 110, then an error message is returned either to consumer device 120 or merchant unit 140. The user is given the option to register as a new user and open a new e-cash account.

The merchant using merchant unit 140 purchases prepaid air time through server 100 and sells it to the consumer having consumer device 120. If, however, the consumer needs to open up a new e-cash account, then a consumer must use the merchant unit 140 located at the merchant premises. The consumer types in his cellular phone identification numbers and his password. His cellular identification numbers are saved as the new e-cash account number and his password is stored in database 110.

To deposit e-cash in the e-cash account, the consumer pays cash to merchant and then the merchant transfers e-cash from his account to the consumer's account. To transfer the value from the merchant account to the consumer account, the merchant uses merchant unit 140 to enter the pre-existing consumer's identification and the value amount to be transferred from the consumer's e-cash account to the merchant's e-cash account.

In step 3, for authorized consumers, the server 100 retrieves consumer account and merchant account information from database 110. If the amount to be transferred is less or equal to the amount in the consumer's account then the funds are transferred from the consumer's account to the merchant account. Specifically, the amount is credited in the merchant account and debited in the consumer account of database 110. Moreover, a record of the details of the transaction is stored in database 110 to generate an itemized bill giving details, for each transaction, of the time, merchant, and amount debited. If the amount to be transferred is greater then the amount in the consumer account, server 100 sends an error message to the consumer device 120 indicating that the transaction could not be completed because of insufficient funds.

In step 4, once the server 100 determines that there are sufficient funds, the server 100 transfers an authorization code to merchant unit 140. The server 100 transfers the amount from the consumer account to the merchant account by updating the values stored, in such accounts, in database 110. The value corresponding to a sum of money is stored in a memory belonging to the account or a value stored in the memory is increased by the value corresponding to a sum of money.

In step 5, server 100 sends a transaction confirmation signal to consumer device 120 indicating that the transaction is completed and that a new transaction, if any, may be started.

The invention having been disclosed in connection with the foregoing variations and examples, additional variations will now be apparent to persons skilled in the art. The invention is not intended to be limited to the variations specifically mentioned, and accordingly reference should be made to the appended claims rather than the foregoing discussion of preferred examples, to assess the scope of the invention in which exclusive rights are claimed.

What is claimed is:

1. Wireless funds transfer system having at least one merchant unit connected to a server, each merchant unit having means for receiving an authorization signal from the server;
the server comprising a database for storing data relating to consumers and merchants of the wireless funds transfer system, and having:
means for receiving consumer data from at least one of a consumer device and a merchant unit;
means for checking the validity of said received data;
means for transferring wireless funds amounts from a consumer account to a merchant account; and
means for transmitting authorization data to the merchant unit.

2. A system according to claim 1, wherein the consumer data is transmitted from the consumer device to the server via a mobile telephone network.

3. A system according to claim 2, further comprising means for transmitting the identity of the consumer device from the mobile telephone to the server.

4. A merchant unit for use in the system of claim 1, comprising means for coupling to the server, such that data may be exchanged between the consumer device and the merchant unit.

5. A system according to any of claim 1, comprising means for transmitting the authorization data over a link between the server and the merchant unit.

6. A system according to any of claim 1, wherein the server comprises a database for storing data relating to consumer and merchant accounts, updateable by means of the data transmitted to the server from at least one of the consumer device and merchant unit.

7. A method for electronic funds transfer, comprising the steps of receiving consumer data at a server from at least one of a consumer device and a merchant unit, checking the validity of said received data; transferring wireless fund values form a consumer account to a merchant account in a database and sending an authorization signal from the server to a merchant device connected thereto.

8. A method according to claim 7, further comprising the step of transmitting a transaction confirmation signal to the consumer device from the server indicating that the transaction is completed and that a new transaction may be started.

9. A method according to claim 7, wherein the consumer data is transmitted from the consumer's device to the server over a network, together with amount of fund value to be transferred.

10. A method according to claim 7, wherein the consumer data is transmitted to the merchant unit for onward transmission to the server.

11. A method according to claim 7, wherein the authorization signal is transmitted over a dedicated line.
